(19) United States
(12) Patent Application Publication
(10) Pub. No.: US 2016/0111721 A1
(43) Pub. Date: Apr. 21, 2016

(54) VOLTAGE-RESPONSIVE COATING FOR LITHIUM-SULFUR BATTERY

(71) Applicants: GM GLOBAL TECHNOLOGY OPERATIONS LLC, Detroit, MI (US); THE REGENTS OF THE UNIVERSITY OF CALIFORNIA, Oakland, CA (US)

(72) Inventors: Qiangfeng Xiao, Troy, MI (US); Mei Cai, Bloomfield Hills, MI (US); Yunfeng Lu, Los Angeles, CA (US); Zheng Chen, Los Angeles, CA (US); Huihui Zhou, Los Angeles, CA (US); Xiaolei Wang, Los Angeles, CA (US)

(73) Assignees: THE REGENTS OF THE UNIVERSITY OF CALIFORNIA, Oakland, CA (US); GM GLOBAL TECHNOLOGY OPERATIONS LLC, Detroit, MI (US)

(21) Appl. No.: 14/889,758

(22) PCT Filed: May 7, 2013
(86) PCT No.: PCT/US2013/039834

§ 371 Date: Nov. 6, 2015

(51) Int. Cl. H01M 4/48; H01M 4/38; H01M 10/0525

(52) U.S. Cl. CPC H01M 4/48; H01M 10/0525; H01M 4/38; H01M 2220/20

(57) ABSTRACT

A sulfur-containing electrode with a surface layer comprising voltage responsive material. The electrode is used in a lithium-sulfur or silicon-sulfur battery.

### FIELD

The present disclosure relates to batteries, particular to lithium-sulfur batteries, and especially to the cathodes of these.

### BACKGROUND

This section provides background information related to the present disclosure that is not necessarily prior art.

Electric-based vehicles or EVs (e.g., hybrid electric vehicles (HEV), battery electric vehicles (BEV), plug-in HEVs, and extended-range electric vehicles (EREV)) require efficient, low-cost, and safe energy storage systems with high energy density and high power capability. Lithium ion batteries can be used as a power source in many applications ranging from vehicles to portable electronics such as laptop computers, cellular phones, and so on. The EVs powered by the current lithium cobalt or lithium-iron phosphate batteries often have a driving range of less than 100 miles (160 km) per charge, while longer driving ranges would be desirable.

A battery based on Li—S chemistry offers an attractive technology that meets the two most pressing issues for electric-based transportation, the needs for low cost and high specific density. Li—S battery technology has been the subject of intensive research and development both in academia and in industry due to its high theoretical specific energy of 2600 Wh/kg as well as the low cost of sulfur. The theoretical capacity of sulfur via two-electron reduction (S+2Li++2e−⇄Li₂S), is 1672 mAh/g (elemental sulfur is reduced to S⁻² anion). The discharge process starts from a crown S8 molecule and proceeds though reduction to higher-order polysulfide anions (Li₂S₈, Li₂S₆) at a high voltage plateau (2.3-2.4 V), followed by further reduction to lower-order polysulfides (Li₂S₄, Li₂S₂) at a low voltage plateau (2.1 V), and terminates with the Li₂S product. During the charge process, Li₂S is oxidized back to S8 through the intermediate polysulfide anions Sₓ. The Sₓ polysulfides generated at the cathode are soluble in the electrolyte and can migrate to the anode where they react with the lithium electrode in a parasitic fashion to generate lower-order polysulfides, which diffuse back to the cathode and regenerate the higher forms of polysulfide. Y. V. Mikhaylik & J. R. Akridge, “Polysulfide Shuttle Study in the Li/S Battery System,” J. Electrochem. Soc., 151, A1969-A1976 (2004) and J. R. Akridge, Y. V. Mikhaylik & N. White, “Li/S fundamental chemistry and application to high-performance rechargeable batteries,” Solid State Ionics, 175, 243-245 (2005) describe this shuttle effect, which leads to decreased sulfur utilization, self-discharge, poor ability to repeatedly cycle through oxidation and reduction, and reduced columbic efficiency of the battery. The insulating nature of S and Li₂S results in poor electrode rechargeablity and limited rate capability. In addition, an 80% volume expansion takes place during discharge. Overall, these factors preclude the commercialization of Li—S batteries for EVs.

To circumvent these obstacles, extensive effort has been devoted to the development of better sulfur cathodes, which has mainly relied on infiltration or in situ growth of sulfur into or onto conductive scaffolds, such as conductive polymers (e.g., polythiophene, polypyrrole, and polyaniline) and porous carbons (e.g., active carbons, mesoporous carbons, hollow carbon spheres, carbon fibers, and graphene). It has been found that, generally, the incorporation of sulfur within conductive polymers results in sulfur/polymer cathodes with improved capacity and cycling stability. The sulfur and the polymer may be crosslinked, leading to electrodes with further improved cycling life. Compared with polymeric scaffolds, carbon scaffolds offer many advantages, such as better stability and conductivity, low cost, and controllable pore structure, which make them more attractive candidates for sulfur cathodes. Polymers (e.g., poly(ethylene oxide) and poly(3,4-ethylenedioxythiophene)-poly(styrene sulfonate)) may be coated on the carbon/sulfur composites to further improve the cycling life and coulomb efficiency. However, despite extensive efforts being made, current sulfur cathodes still fail to meet the requirement of high-performance Li/S batteries. Current sulfur cathodes do not sufficiently retard polysulfide migration to be able to prolong cathode cycling life. During discharge of current sulfur/carbon cathodes, the cyclic S₈ molecules are converted to polysulfides (Li₂Sₙ, 2<n<8) that are smaller than the S₈ molecules. Driven by the concentration gradient, the polysulfides unavoidably diffuse away from the cathodes, causing fast capacity fading with poor cycling life. Nevertheless, a functioning cathode also requires effective lithium ion transport between the electrolyte and the electrodes. Because electrolyte molecules, lithium ions, and the polysulfides exhibit comparable diffusion coefficients, carbon materials that are able to retard the outward polysulfide diffusion will also retard the transport of electrolyte and lithium ions, resulting in poor rate performance or even dysfunction of the cathode. This fundamental dilemma has until now prevented the art from realizing the great potential of Li/S batteries.

### SUMMARY

This section provides a general summary and not necessarily a comprehensive disclosure of the invention and all of its features.

Disclosed is a sulfur-containing electrode with an outer surface including voltage responsive metal compound that expands in volume when the metal of the compound is reduced in oxidation state.

Also disclosed is a battery with a sulfur-containing cathode having in pores of its outer surface a voltage responsive material that expands in volume during battery discharge. The expanded volume of the voltage responsive material slows or at least partially prevents outward diffusion of polysulfide compounds from the cathode, resulting in improved cycling stability (capacity retention with repeated cycles of discharge and recharge of the battery). The battery may be a lithium-sulfur or silicon-sulfur battery.

Further disclosed is a battery that has a sulfur-containing cathode having in its outer surface pores a reducible transition metal oxide, the transition metal oxide being one that, in its reduced state, is permeable to lithium ions but slows or at least partially prevents outward diffusion of polysulfide compounds from the cathode. The battery may be a lithium-sulfur or silicon-sulfur battery.

In various embodiments the transition metal oxide forms a lithium transition metal compound during battery discharge.

In one aspect, a sulfur-containing cathode has vanadium oxide (V₂O₅) deposited or coated in pores of an outer surface layer. The vanadium oxide forms LiₓV₂O₅ during discharge of a Li/S battery. The LiₓV₂O₅ during discharge compound has a greater volume than V₂O₅, slowing or at least partially preventing outward diffusion of polysulfides from the cathode when it forms while allowing transport of Li⁺ during discharge of the battery. A Li/S or Si/S battery having a sulfur-containing cathode with a voltage-responsive material such as vanadium oxide in its pores has improved cycling stability over a battery in which the cathode lacks the voltage-responsive material.

Also disclosed is a method of increasing the capacity retention of Li/S or Si/S batteries by reducing or blocking outward polysulfide diffusion from a sulfur/carbon cathode of the battery introducing into pores on the surface of the cathode a voltage-responsive material that increases in volume during battery discharge to selectively block outward polysulfide diffusion from the cathode while allowing effective lithium ion transport into the cathode. The voltage-responsive material may be a transition metal compound.

In various embodiments, the voltage-responsive material is a transition metal oxide or a mixed oxide of two or more transition metals.

In another aspect, a method of making a voltage-responsive sulfur-containing electrode is disclosed, in which a porous sulfur-containing electrode is infiltrated at its surface with a solution of a transition metal alkoxide in anhydrous solvent to deposit in pores or coat in pores the transition metal alkoxide; the solvent is evaporated, the transition metal alkoxide is hydrolyzed with water (for example in the form of water vapor) and then annealed (for example at 100° C. to 150° C.) to form the sulfur-containing electrode having an outer layer including a transition metal oxide in pores of the electrode.

A method of making a lithium-sulfur or silicon-sulfur cell or battery is disclosed, in which a porous sulfur-containing electrode with a transition metal oxide in its pores, particularly in pores at its surface, is connected as the battery cathode. The transition metal oxide expands in volume to constrict passage of polysulfides when voltage is applied to the cell or battery.

In discussing the disclosed electrodes and batteries and methods of making and using them, “a,” “an,” “the,” “at least one,” and “one or more” are used interchangeably to indicate that at least one of the item is present; a plurality of such items may be present unless the context clearly indicates otherwise. The terms “comprises,” “comprising,” “including,” and “having,” are inclusive and therefore specify the presence of stated items, but do not preclude the presence of other items. The term “or” includes any and all combinations of one or more of the associated listed items. When the terms first, second, third, etc. are used to differentiate various items from each other, these designations are merely for convenience and do not limit the items.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings illustrate some aspects of the disclosed technology.

FIG. 1 is schematic illustration of one configuration for a lithium sulfur cell;

FIG. 2 is an idealized representation of a response of an anode surface layer of intercalated vanadium oxide during battery discharge;

FIG. 3 is a graph comparing cycling stability of vanadium oxide-coated and uncoated sulfur-carbon electrodes; and

FIG. 4 is a graph showing the cycling stability of a vanadium oxide-coated electrode at a high rate.

### DETAILED DESCRIPTION

A detailed description of exemplary, nonlimiting embodiments follows.

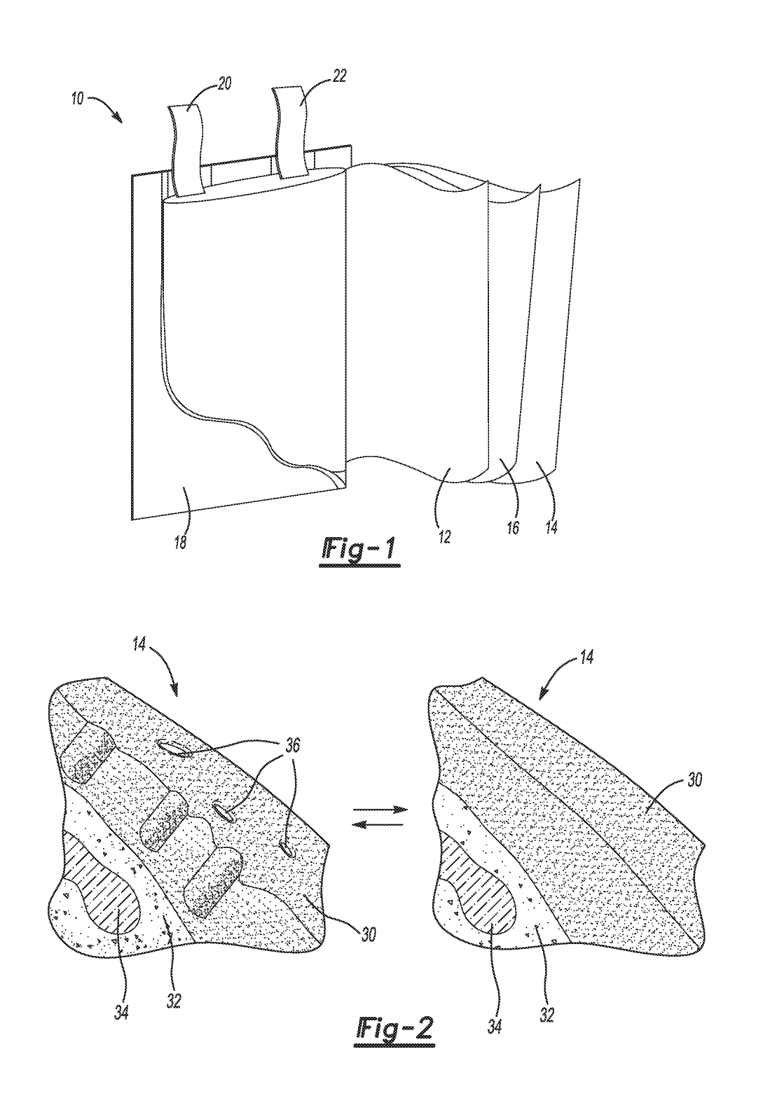

Referring first to the Figures, FIG. 1 illustrates one configuration for a lithium sulfur or silicon sulfur cell or battery 10 in which sheets of a anode 12 and cathode 14, separated by a sheet of a polymer separator 16, are wound together or stacked in alternation inside of a cell enclosure 18. The polymer separator 16 is electrically nonconductive and ion-pervious via the electrolyte solution that fills its open pores. For example the polymer separator 16 is a microporous polypropylene or polyethylene sheet. The enclosure 18 contains a nonaqueous lithium salt electrolyte solution to conduct lithium ions between the electrodes. The anode connects to an anode current collector 20; the cathode connects to a cathode current collector 22. The terminals can be connected in a circuit to either discharge the battery by connecting a load (not shown) in the circuit or charge the battery by connecting an external power source (not shown). The anode 12 is a lithium anode in a lithium sulfur battery or is a silicon anode in a silicon sulfur battery.

The lithium sulfur or silicon sulfur cell can be shaped and configured to specific uses as is known in the art. For examples, the loads may be electric motors for automotive vehicles and aerospace applications, consumer electronics such as laptop computers and cellular phones, and other consumer goods such as cordless power tools, to name but a few. The load may also be a power-generating apparatus that charges the lithium sulfur battery 10 for purposes of storing energy. For instance, the tendency of windmills and solar panel displays to variably or intermittently generate electricity often results in a need to store surplus energy for later use. Lithium sulfur batteries may be configured in four general ways: (1) as small, solid-body cylinders such as laptop computer batteries; (2) as large, solid-body cylinders with threaded terminals; (3) as soft, flat pouches, such as cell phone batteries with flat terminals flush to the body of the battery; and (4) as in plastic cases with large terminals in the form of aluminum and copper sheets, such as battery packs for automotive vehicles.

The battery 10 can optionally include a wide range of other components known in the art, such as gaskets, seals, terminal caps, and so on for performance-related or other practical purposes. The battery 10 may also be connected in an appropriately designed combination of series and parallel electrical connections with other similar lithium or silicon sulfur batteries to produce a greater voltage output and current if the load so requires.

A lithium sulfur battery 10 can generate a useful electric current during battery discharge by way of reversible electrochemical reactions that occur when an external circuit is closed to connect the anode 12 and the cathode 14 at a time when the cathode contains electrochemically active lithium. The average chemical potential difference between the cathode 14 and the anode 12 drives the electrons produced by the oxidation of intercalated lithium at the anode 12 through an external circuit towards the cathode 14. Concomitantly, lithium ions produced at the anode are carried by the electrolyte solution through the microporous polymer separator 16 and towards the cathode 14. At the same time with Li⁺ ions entering the solution at the anode, Li⁺ ions from the solution recombine with electrons at interface between the electrolyte and the cathode, and the lithium concentration in the active material of the cathode increases. The electrons flowing through an external circuit reduce the lithium ions migrating across the microporous polymer separator 16 in the electrolyte solution to form intercalated lithium cathode 14. The electric current passing through the external circuit can be harnessed and directed through the load until the intercalated lithium in the anode 12 is depleted and the capacity of the battery 10 is diminished below the useful level for the particular practical application at hand.

The lithium sulfur battery 10 can be charged at any time by applying an external power source to the lithium sulfur battery 10 to reverse the electrochemical reactions that occur during battery discharge and restore electrical energy. The connection of an external power source to the lithium sulfur battery 10 compels the otherwise non-spontaneous oxidation of the lithium polysulfides at the cathode 14 to produce electrons and lithium ions. The electrons, which flow back towards the anode 12 through an external circuit, and the lithium ions, which are carried by the electrolyte across the polymer separator 16 back towards the anode 12, reunite at the anode 12 and replenish it with intercalated lithium for consumption during the next battery discharge cycle.

A lithium sulfur anode 12 has a base electrode material such as lithium metal, which can serve as the anode active material. The lithium metal may be in the form of, for example, a lithium metal foil or a thin lithium film that has been deposited on a substrate. The lithium metal may also be in the form of a lithium alloy such as, for example, a lithium-tin alloy, a lithium aluminum alloy, a lithium magnesium alloy, a lithium zinc alloy, a lithium silicon alloy, or some combination of these.

The anode 12 may alternatively include any lithium host material that can sufficiently undergo lithium intercalation and deintercalation while functioning as the anode of the lithium ion battery 10. Examples of host materials include electrically conductive carbonaceous materials such as carbon, graphite, carbon nanotubes, graphene, and petroleum coke, as well as transition metals and their electrically conductive oxides such as silicon, titanium dioxide, silicon dioxide, tin oxide, ion oxides, and manganese dioxide, or silicon and silicon oxides. Mixtures of such host materials may also be used. Graphite is widely utilized to form the anode because it is inexpensive, exhibits favorable lithium intercalation and deintercalation characteristics, is relatively non-reactive, and can store lithium in quantities that produce a relatively high energy density. Commercial forms of graphite that may be used to fabricate the anode 12 are available from, for example, Timcal Graphite & Carbon, headquartered in Bodio, Switzerland, Lonza Group, headquartered in Basel, Switzerland, Superior Graphite, headquartered in Chicago, Ill. USA, or Hitachi Chemical Company, located in Japan.

A silicon sulfur battery includes a porous silicon anode, for example prepared with silicon nanoparticles made from high purity silicon.

The anode includes a polymer binder material in sufficient amount to structurally hold the lithium host material together. Nonlimiting examples of suitable binder polymers include polyvinylidene fluoride, polyacrylonitrile, polyethylene oxide, polyethylene, polypropylene, polytetrafluoroethylene, polybutadiene, polystyrene, polyalkyl acrylates and methacrylates, ethylene-(propylene-diene-monomer)-copolymer (EPDM) rubber, copolymers of styrene and butadiene, and mixtures of such polymers.

The anode current collector 20 may be formed from copper or any other appropriate electrically conductive material known to skilled artisans.

Cathode 14 is a porous sulfur-containing electrode. A porous sulfur-containing electrode in general has porous conductive carbonaceous material or other host material, e.g., conductive polymers or metal oxides, such as any of those already mentioned as useful in the electrode that is infiltrated with sulfur, which in its metallic form is a crown S₈ molecule. As the battery is discharged, the cyclic S₈ is reduced through a series of increasingly smaller volume lithium sulfide compounds via two-electron reduction (from elemental sulfur through the series Li₂S₈, Li₂S₆, Li₂S₄, Li₂S₂). As the battery is charged, the sulfides are oxidized back to crown S₈. The materials of the positive electrode, including the active lithium-transition metal compound and conductive carbon or other conductive host material, are held together by means of a binder, such as any of those already mentioned above.

As shown by the diagram of FIG. 2, the cathode 14 has a porous host material 32 containing sulfur 34. The cathode 14 has an outer layer 30 in which pores or openings 36 of the host material 32 at the cathode's surface are infiltrated with voltage-responsive material. The voltage responsive material is a material that expands in volume during battery discharge while sulfur 34 is reduced to smaller-volume compounds, as represented by the configuration on the right-hand side of FIG. 2. The expanded volume of the voltage responsive material in outer layer 30 at least partially plugs pore openings 36, as shown by the lack of pore openings 36 in outer layer 30 on the right-hand side of the arrows, to slow or prevent egress of the lower volume polysulfides being formed, while still permitting ingress of lithium ions. For example, this may happen as a transition metal compound forms a lithium-transition metal compound.

In one method, a sulfur-containing cathode may be prepared using a high-pore-volume carbon scaffold, then infiltrating the scaffold with molten crown S₈. Porous carbon particles may be synthesized using an aerosol or spraying process. To control the pore structure, surfactants (e.g., surfactants that are block copolymers of ethylene oxide and propolyene oxide, such as those sold by BAST under the trademark PLURONIC®), silicate clusters, and silica colloidal particles of different sizes can be used as the porogens (templates) for forming pores. Pore volume may be controlled by adjusting the amount of the porogens added. Carbonization conditions (e.g., temperature and time) are controlled to ensure high electrical conductivity. Carbon nanotube networks (CNTs) may also be added into the carbon particle precursor solutions to further improve the conductivity and the rate capability. High pore volume permits high sulfur loading; however, this must be balanced against a need to maintain adequate electrical conductivity.

For example, in one synthesis of highly porous carbon particles with a surface area of 1219.4 m²/g and a pore volume of 4.01 cm³/g, 2-3 g of sucrose and 4 g of colloidal silica solution (20-30 nm) were added to 10 mL of 0.1 M HCl until completely dissolved. The resulting solution was employed as a precursor solution and was then sent through the aerosol atomizer (TSI model 3076) to produce aerosol droplets using 40 psi nitrogen as a earner gas. The resulting particles were heated to 900° C. at a rate of 3° C./min and held for 4 h under nitrogen flow. A black powder was then collected and immersed in a 5 M NaOH solution and stirred for 48 h. The solution was then filtered, rinsed several times with deionized water, and dried in an oven at 100° C. The porous conductive carbon or other host material (e.g., conductive polymers or metal oxides) is infiltrated with molten sulfur and then mixed with a binder and optionally additives and formed into an electrode.

Finally, an outer surface layer is coated or infiltrated with a transition metal compound that reduces when voltage is applied to expand in volume and constrict the outer cathode pores to slow or prevent elution into the electrolyte of the lower volume, reduced sulfide compounds being formed when a battery is discharging.

The porous sulfur-containing electrode is infiltrated at least at its surface with a voltage responsive material. In one method, this may be done by introducing into the pores a solution of a transition metal alkoxide, for example a transition metal isopropoxide, in anhydrous solvent such as tetrahydrofuran or ethanol to deposit in pores or coat in pores the transition metal alkoxide. Nonlimiting examples of suitable transition metal alkoxides include the ethoxides, isopropoxides, and tert-butoxides of vanadium, titanium, molybdenum, and zirconium; these may be used in combination to prepare mixed metal oxides. After being introduced into the pores of the cathode, the solvent is evaporated and the transition metal alkoxide is hydrolyzed with water (for example in the form of water vapor) and then annealed (for example at 100° C. to 150° C.) for 24 hours to form the sulfur-containing electrode having an outer layer including 2 wt. % a transition metal oxide in pores of the electrode.

The cathode current collector 22 may be formed from aluminum or another appropriate electrically-conductive material.

An electrically insulating separator 16 is generally included between the electrodes, such as in batteries configured as shown in FIG. 1. The separator must be permeable for the ions, particularly lithium ions, to ensure the ion transport for lithium ions between the positive and the negative electrodes. Nonlimiting examples of suitable separator materials include polyolefins, which may be homopolymers or a random or block copolymers, either linear or branched, including polyethylene, polypropylene, and blends and copolymers of these; polyethylene terephthalate, polyvinylidene fluoride, polyamides (nylons), polyurethanes, polycarbonates, polyesters, polyetheretherketones (PEEK), polyethersulfones (PES), polyimides (PI), polyamide-imides, polyethers, polyoxymethylene (acetal), polybutylene terephthalate, polyethylene naphthenate, polybutene, acrylonitrile-butadiene styrene copolymers (ABS), styrene copolymers, polymethyl methacrylate, polyvinyl chloride, polysiloxane polymers (such as polydimethylsiloxane (PDMS)), polybenzimidazole, polybenzoxazole, polyphenylenes, polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers, polyaramides, polyphenylene oxide, and combinations of these.

The microporous polymer separator 16 may be a woven or nonwoven single layer or a multi-layer laminate fabricated in either a dry or wet process. For example, in one example, the polymer separator may be a single layer of the polyolefin. In another example, a single layer of one or a combination of any of the polymers from which the microporous polymer separator 16 may be formed (e.g., the polyolefin or one or more of the other polymers listed above for the separator 16). As another example, multiple discrete layers of similar or dissimilar polyolefins or other polymers for the separator 16 may be assembled in making the microporous polymer separator 16. In one example, a discrete layer of one or more of the polymers may be coated on a discrete layer of the polyolefin for the separator 16. Further, the polyolefin (and/or other polymer) layer, and any other optional polymer layers, may further be included in the microporous polymer separator 16 as a fibrous layer to help provide the microporous polymer separator 16 with appropriate structural and porosity characteristics. A more complete discussion of single and multi-layer lithium ion battery separators, and the dry and wet processes that may be used to make them, can be found in P. Arora and Z. Zhang, “Battery Separators,” Chem. Rev., 104, 4424-4427 (2004).

Suitable electrolytes for the lithium sulfur or silicon sulfur batteries include nonaqueous solutions of lithium salts. Nonlimiting examples of suitable lithium salts include lithium hexafluorophosphate, lithium hexafluoroarsenate, lithium bis(trifluoromethlysulfonylimide), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, and combinations of these.

The lithium salt is dissolved in a non-aqueous solvent, which may be selected from: ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, or an ionic liquid, and mixtures of two or more of these solvents.

The electrolyte may further include one or more appropriate additives, such as any of those disclosed in S. S. Zhang, “J. Power Sources,” 162 (2006) 1379-1394 (available at www.sciencedirect.com), for example additives to increase the mobility of lithium ions.

When the lithium sulfur or silicon sulfur battery discharges, the voltage responsive material, e.g., a reducible transition metal oxide, expands in volume, for example by forming a lithium transition metal compound. In one embodiment, the voltage responsive material is V₂O₅, which forms LiₓV₂O₅ (x<2.5) during discharge. The expanded volume of the voltage responsive material slows or at least partially prevents outward diffusion of polysulfide compounds from the cathode, resulting in improved cycling stability (capacity retention with repeated cycles of discharge and recharge of the battery). For example, when a mesoporous carbon-sulfur cathode is treated in this was with V₂O₅, the LiₓV₂O₅ formed during discharge prevents (at least to a large extent) polysulfides from leaching from the cathode but allows lithium ions into the cathode for continued satisfactory battery operation. Among other suitable transition metal oxides and mixed transition metal oxides are titanium dioxide, molybdenum dioxide, molybdenum trioxide, and mixed oxides of two or more of vanadium, titanium, and molybdenum.

The voltage responsive material may have a volume increase of at least about 10%, for example 10%-40% in response to voltage during battery discharge. The particular voltage responsive material is selected, and the average pore size of the cathode (at least at its surface) is controlled to obtain a desired amount of blocking of the pore by the volume increase.

The following nonlimiting example illustrates the scope of the methods and compositions as described and claimed. All parts are parts by weight unless otherwise noted.

### Example

To prepare the vanadium oxide coated sulfur/carbon cathode, the sulfur/carbon cathode was soaked in ethanol solution containing triisopropoxide vanadium oxide at room temperature and stirred for a specific duration. The concentration and duration time could be adjusted to modify the amount of V₂O₅ coated on sulfur/carbon cathode. The coated cathode was collected by centrifugation and dried at 70° C. in air allowing complete hydrolysis of vanadium precursor.

A conventional slurry-coating process was used to fabricate electrode. The vanadium oxide coated sulfur/carbon cathode, carbon black and polyvinylidenedifluoride (PVDF) binder were mixed in a mass ratio of 80:5:15, and homogenized in N-methylpyrrolidinone (NMP) to form slurries. The homogeneous slurries were coated onto aluminum foil substrates and dried at 70° C. in air for 5 hrs. The mass loading of active materials was controlled to be 1.25 to 3.75 mg cm-2 on each current collector. To test the electrode, 2032-type coin cells were assembled in an argon-filled glovebox, using Celgard 2500 membrane as the separator, lithium foil as the counter electrode.

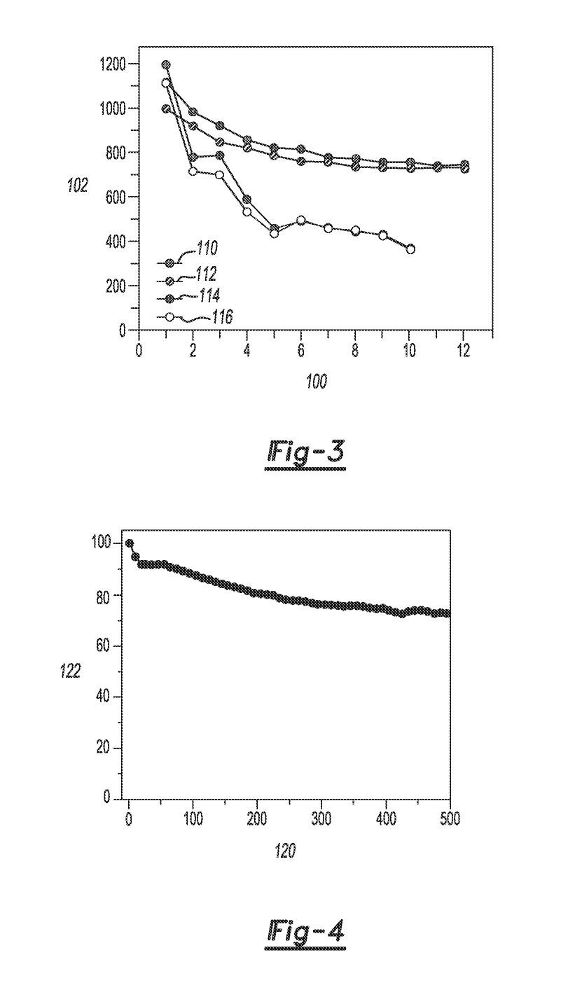

FIG. 3 is a graph in which the capacity versus cycle number of the cathode of the Example is compared to that of a control cathode that was not treated with the vanadium oxide but that was otherwise the same. The y-axis 102 is capacity (mAh/g-s) and the x-axis 100 is cycle number. Line 1110 is the Example being charged; line 112 is the Example being discharged. Line 114 is the uncoated control cathode being charged; line 116 is the uncoated control cathode being discharged. This comparison shows that the vanadium oxide treatment was highly effective in increasing capacity retention with repeated cycles of discharge and recharge of the battery.

FIG. 4 is a graph in which the capacity retention (%, on y-axis 122) versus cycle number (on x-axis 120) out to 500 cycles is plotted for the cathode of the Example.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A sulfur-containing electrode with a surface layer comprising voltage responsive material.

2. A battery comprising the electrode of claim 1.

3. A battery according to claim 2, wherein the voltage responsive material is a transition metal compound.

4. A according to claim 3, wherein the transition metal compound is deposited or coated in pores in the surface layer.

5. A battery according to claim 3, wherein the transition metal compound forms a lithium transition metal compound during battery discharge.

6. A battery according to claim 3, wherein the transition metal compound has a volume expansion of at least about 10% during battery discharge as compared to its volume when the battery is fully charged.

7. A battery according to claim 3, wherein the transition metal compound comprises vanadium oxide.

8. A battery according to claim 3, wherein the surface layer is mesoporous.

9. A battery according to claim 2, wherein the battery is a lithium sulfur battery.

10. A battery according to claim 2, wherein the battery is a lithium silicon battery.

11. A method of improving cycling stability of a lithium sulfur or silicon sulfur battery, comprising infiltrating pores of a sulfur-containing cathode of the battery with a transition metal compound that expands in volume during discharge of the battery.

10. A method according to claim 11, wherein the expansion slows or prevents egress of polysulfides from the cathode.

12. A method according to claim 11, wherein the transition metal compound forms a lithium transition metal compound during discharge of the battery.

13. A method according to claim 11, wherein the transition metal compound is a transition metal oxide.

14. A method according to claim 11, wherein the transition metal compound comprises vanadium oxide.

15. A method of preparing a sulfur-containing electrode, comprising:
preparing a porous sulfur-containing electrode having a surface with pores;
infiltrating the pores with a transition metal alkoxide;
hydrolyzing the alkoxide; and
annealing the electrode.

16. A method according to claim 15, wherein the transition metal is selected from vanadium, molybdenum, titanium, and combinations thereof.
